(19) United States
(12) Patent Application Publication
(10) Pub. No.: US 2007/0200482 A1
(43) Pub. Date: Aug. 30, 2007

(54) IMAGE DISPLAY APPARATUS AND METHOD OF MANUFACTURING THE SAME

(76) Inventors: Hitoshi TABATA, Hiratsuka-shi (JP); Nobuo Kawamura, Fukaya-shi (JP); Takeo Ito, Kumagaya-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/689,123

(22) Filed: Mar. 21, 2007

Related U.S. Application Data
(63) Continuation of application No. PCT/JP05/17824, filed on Sep. 28, 2005.

(30) Foreign Application Priority Data
Sep. 30, 2004 (JP) 2004-286639

(51) Int. Cl. H01J 63/04; H01J 1/62; H01J 9/00; H01J 9/38

(52) U.S. Cl. 313/495; 313/497; 445/24; 445/38

(57) ABSTRACT

A metal back layer and a getter layer of an image display apparatus according to the present invention is given an electrically discontinuous characteristic by a porous getter cut material having a number of gaps (holes) of predetermined size with respect to the magnitude of impurities to be absorbed. Therefore, a discharge start voltage upon an electric discharge is increased, that is, a discharge withstand voltage is increased.

### CROSS REFERENCE TO RELATED APPLICATIONS

This is a Continuation Application of PCT Application No. PCT/JP2005/017824, filed Sep. 28, 2005, which was published under PCT Article 21(2) in Japanese.

This application is based upon and claims the benefit of priority from prior Japanese Patent Application No. 2004-286639, filed Sep. 30, 2004, the entire contents of which are incorporated herein by reference.

### BACKGROUND OF THE INVENTION

1. Field of the Invention

The present invention relates to an image display apparatus, and a method of manufacturing the same. More particularly, the invention relates to an image display apparatus which has an electron source and a fluorescent surface to display an image by emitting an electron beam, in a vacuum housing, and a method of manufacturing the image display apparatus.

2. Description of the Related Art

A cathode-ray tube (CRT), which is widely used as an image display apparatus, emits an electron beam to fluorescent elements to light the fluorescent elements, and displays an image as a result.

In recent years, there has been developed an image display apparatus provided with many electron-emitting elements (electron source) which selectively emit electron beams to a flat fluorescent screen arranged in a plane and opposed across a predetermined interval, and outputs fluorescence (displays an image). This (plane type) image display apparatus is called a field emission display (FED). In an FED, a display apparatus using a surface transmission emitter as an electron source is classified as a surface transmission type electron emission display (SED). In this application, the term FED is used as a generic name including an SED.

A field emission display (FED) can be made by setting a clearance between an electron source substrate and a fluorescent surface substrate to several millimeters or less. Therefore, an FED can be made thinner than a well-known CRT, and equivalent to or thinner than a flat display unit like an LCD. An FED can be made light in weight.

An FED is a self-emission type like a CRT and a plasma display, and displays an image with high brightness.

On the fluorescent surface provided inside the front substrate, red (R), blue (G) and green (G) fluorescent substances are arranged in predetermined size and order. Each fluorescent substrate on the fluorescent surface is connected to an anode electrode to give each fluorescent substance a predetermined sweep voltage.

On the electron source substrate, a scanning line and signal line are connected like a matrix to let a specific emitter emit a predetermined amount of electron to illuminate a fluorescent surface opposite to an emitter at an optional position.

In an FED, the light of image output from a fluorescent substance reflects on a display surface of a front substrate, or a visible surface for an observer, and increases to brightness of an image. Therefore, a metal back layer that is a thin layer of metallic material is provided on a fluorescent substance, or on the side opposite to an electron source substrate in the assembled state.

A metal back layer functions as an anode for an electron source, or an emitter.

Further, in an FED, the substrates of electron source and fluorescent surface are opposed with a clearance of several millimeters or less, and the degree of vacuum is held at approximately 10⁻⁴ Pa. It is thus well known that if an internal pressure is increased by gas generated inside, the amount of electron emitted from an electron source is decreased, and the luminance of an image is decreased. Therefore, it is proposed to provide a getter material to absorb the gas generated inside, at a desired position except a fluorescent surface or an image display area.

According to the structure of an FED, a high voltage of approximately 10 kV is applied to between a front substrate and an electron source substrate. It is known that a discharge generating a large discharge current of 100 A, or a vacuum arc discharge is likely to occur between a metal back layer as an anode and an electron source as an emitter. In the circumstances, Jpn. Pat. Appln. KOKAI Publication No. 10-326583 proposes a method of securing a high anode voltage by dividing a metal back layer into a plurality of parts, and connecting to an anode power supply as a common electrode through a resistor member.

Jpn. Pat. Appln. KOKAI Publication No. 2000-311642 discloses a technique to increase an effective impedance of a fluorescent surface by forming a zigzag pattern of notches on a metal back layer.

An example of dividing a metal back layer into several parts and arranging a getter material among the divided metal backs has been reported by the development group including the applicant of the present invention (refer to Jpn. Pat. Appln. KOKAI Publication No. 2003-68237).

The above patent documents report that generation of an electric discharge can be prevented by dividing a metal back layer functioning as an anode into an optional number of parts. However, actually, it is difficult to completely prevent generation of an electric discharge, owing to the space between a phase plate and an electron source substrate, the magnitude of voltage applied to an anode, and changes over time.

The magnitude of a discharge current on the occurrence of an electric discharge is decreased to a certain extent, but it is an unavoidable problem that a discharge current larger than a value not to affect display of image flows.

When the size of each pixel on a faceplate is assumed to have a 0.6 mm pitch, fluorescent substances of three colors R, G and B which can output light beams corresponding to three prime colors are arranged with a space of several micrometers maximum. The space is approximately 100 μm with respect to the length direction extending like a belt of the fluorescent substance.

Therefore, even if a conventional method, such as vacuum evaporation, CVD and spattering, is used to partition to give a predetermined shape to a getter material that may be a single unit combined with a metal back layer, for example, a problem remains. Suitable shape and precision are not obtained due to the precision of a mask material and the accuracy in positioning the mask material and fluorescent substance, and an abnormal discharge is not prevented.

Besides, even if a suitable shape can be given to a getter material or a metal back layer combined with a getter material, many steps are required, including a step of arranging three kinds of fluorescent substance on a faceplate, a step of forming a light shielding layer as a frame material to partition the fluorescent substance on a faceplate, a step of forming a getter material to a predetermined thickness on a fluorescent substance, and a step of patterning a getter material, or a metal back layer combined with a getter layer, in a predetermined shape. These steps decrease productivity.

The method and structure described in the above patent applications are not necessarily applied to a mass production process in a preferable form.

### BRIEF SUMMARY OF THE INVENTION

It is an object of the present invention to provide an image display apparatus with high quality display image, which can decrease the magnitude of the discharge current even if an electric discharge occurs between an electron source substrate and a fluorescent surface substrate, and a method of manufacturing the image display apparatus.

This invention is provided an image display apparatus comprising a first substrate which holds an electron beam source; and a second substrate which is opposite to the first substrate with a predetermined space, and holds a fluorescent substance layer to output a predetermined color light when receiving an electron beam output from the electron beam source, a light-shielding member to partition the fluorescent layer for each color, a thin metallic layer to cover the light-shielding member and fluorescent substance layer and to give a sweep voltage to an electron beam from the electron beam source, an impurity absorbing layer for absorbing impurities laminated on the thin metallic layer, and a cut member to partition at least one of the thin metallic layer and impurity absorbing layer to have an electrical resistance higher than a predetermined value; and the first and second substrates enclosed to a predetermined vacuum,

wherein the cut member is formed with main material of predetermined size arranged indefinitely, and made of porous material including a number of holes.

Also, this invention is provided an image display apparatus comprising: a first substrate which holds an electron beam source; a second substrate which is opposite to the first substrate with a predetermined space, and holds a fluorescent substance layer to output a predetermined color light when receiving an electron beam output from the electron beam source, a light-shielding member to partition the fluorescent layer for each color, a thin metallic layer covering the light-shielding member and fluorescent substance layer, formed at a predetermined angle in the light-shielding member to give a sweep voltage to an electron beam from the electron beam source, an impurity absorbing layer for absorbing impurities laminated on the thin metallic layer, and a cut member to partition at least one of the thin metallic layer and impurity absorbing layer to have an electrical resistance higher than a predetermined value; a frame body which keeps the first and second substrate airtight with a predetermined space; and a spacer member which keeps the predetermined space between the first and second substrates, and increases the intensity between the first and second substrates when keeping airtightness through the frame body.

Further, this invention is provided a method of manufacturing an image display apparatus, comprising: forming a light-shielding layer on one side of a substrate; forming R, G, B fluorescent substances in a predetermined order like a matrix in a section defined by a light-emitting layer; eliminating a light-emitting layer along one direction of at least row or column direction of the light-emitting layer; placing a porous material having a number of holes and shaped indefinite with predetermined size of main material arranged irregularly, in an area where the light-emitting layer is eliminated; forming a thin metallic film on the light-shielding layer formed like a matrix; providing a getter material for absorbing impurities over the thin metallic film; opposing to the substrate provided with an electron source; and evacuate to a predetermined vacuum after sealing the substrates.

### BRIEF DESCRIPTION OF THE SEVERAL VIEWS OF THE DRAWING

FIG. 1 is a perspective view of an image display apparatus (FED) according to an embodiment of the invention;

FIG. 2 is a sectional view of the FED taken along lines I-I of FIG. 1;

FIG. 3 is a plan view for explaining an example of configuration of the FED of a fluorescent surface in the FED shown in FIG. 2;

FIG. 4 is an enlarged plan view of a part close to the a fluorescent surface of the FED shown in FIG. 2;

FIG. 5 is a sectional view of a fluorescent surface taken along lines II-II of FIG. 4;

FIG. 6 is a photo-micrograph showing the state of a getter cut material in experiment 1;

FIG. 7 is a photo-micrograph showing the state of a getter cut material in experiment 2; and

FIG. 8 is a photo-micrograph showing the state of a getter cut material in a comparative example.

### DETAILED DESCRIPTION OF THE INVENTION

Hereinafter, embodiments of the invention will be explained in detail with reference to the accompanying drawings.

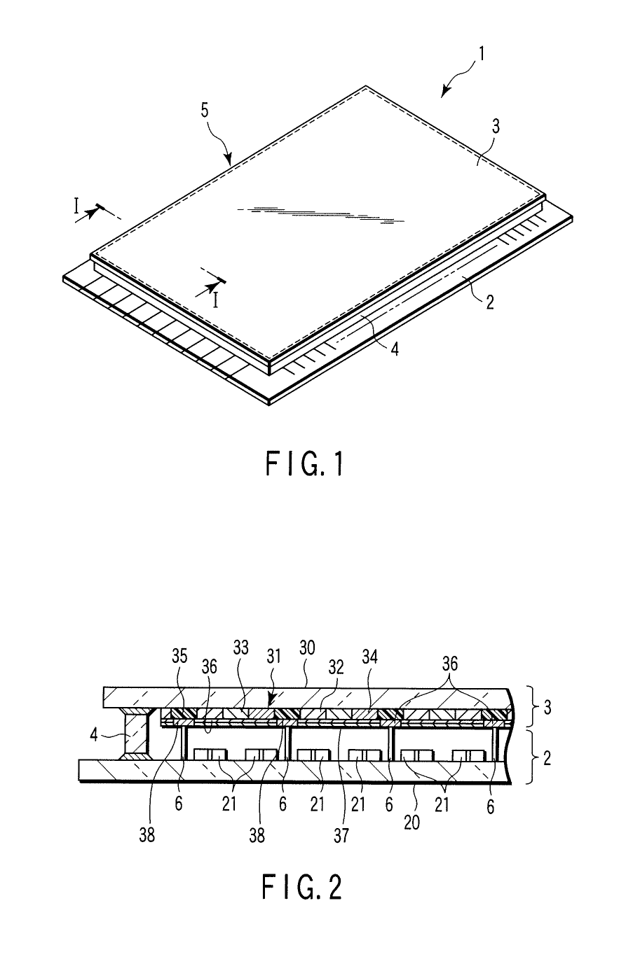

FIG. 1 and FIG. 2 show the structure of a flat image display apparatus, field emission display (FED) according to an embodiment of the invention.

An image display apparatus FED 1 has an electron source substrate 2 having a plurality of electron-emitting elements called an electron source or emitter on a plane (a first substrate, hereinafter called a rear panel), and a fluorescent surface substrate 3 (a second substrate, hereinafter called a faceplate) which is opposed to the rear panel 2 with a predetermined space, and emits a fluorescent light when receiving an electron beam from an emitter.

On the rear panel 2, a plurality of the above-mentioned electron emitting elements, or an emitter, is arranged flat like a matrix. On the faceplate 3, a plurality of fluorescent substances to emit three primary colors red (R), green (G) and blue (B) in an additive process is partitioned substantially corresponding to the emitters on the rear panel 2.

As shown in FIG. 2, the rear panel 2 and faceplate 3 include a glass base material 20 that is a rectangular rear side namely an electron source, and a glass base material 30 that is a front side namely a fluorescent surface, each of which is formed rectangular and given predetermined area. In the main area as a display area of the base materials 20 and 30, predetermined numbers of electron sources as electron emitting elements and fluorescent substance as light-emitting elements are provided.

The substrates 2 and 3, or the glass base materials 20 and 30 are opposed with a gap (space) of 1-2 mm, and joined by a side wall 4 provided at the peripheral edge portions of the substrates 2 and 3, as shown in FIG. 2. Namely, the FED 1 is made as an airtight outer enclosure 5 by the substrates 2 and 3 and the side wall 4. The inside of the outer enclosure 5 is held in a vacuum of approximately 10⁻⁴ Ps. Between the glass base materials of the rear panel 2 and faceplate 3, a number of plate-like or column-like spacers 6 is arranged in order to resist atmospheric pressure acting on each glass material in the state assembled as an outer enclosure 5.

On one side of the glass material 30 used as a faceplate 3, or the surface facing the inside when assembled as an outer enclosure 5, a fluorescent surface 31 with the R, G and B fluorescent substances arranged in a predetermined order is formed. As described in details later, a thin metallic film functioning as an anode electrode, or a metal back layer, is provided. Between the electron source and the metal back layer as an anode electrode, a sweep voltage of 10-15 kV is applied.

On one side of the glass base material 20 of the rear panel 2 (first substrate), or the surface facing the inside when assembled as an outer enclosure 5, a plurality of emitters 21 as electron-emitting element to selectively emit an electron beam is provided on the fluorescent surface 32 of the faceplate 3, as explained above.

The emitter 21 as an electro source is arranged in 800 rows×3 and 600 columns corresponding to each pixel as one unit formed by fluorescent substance layers 32 (R), 33 (G) and 34 (B) formed on the faceplate 3. The emitter 21 is driven through a matrix wiring connected to a not-shown scanning line driving circuit and signal line driving circuit.

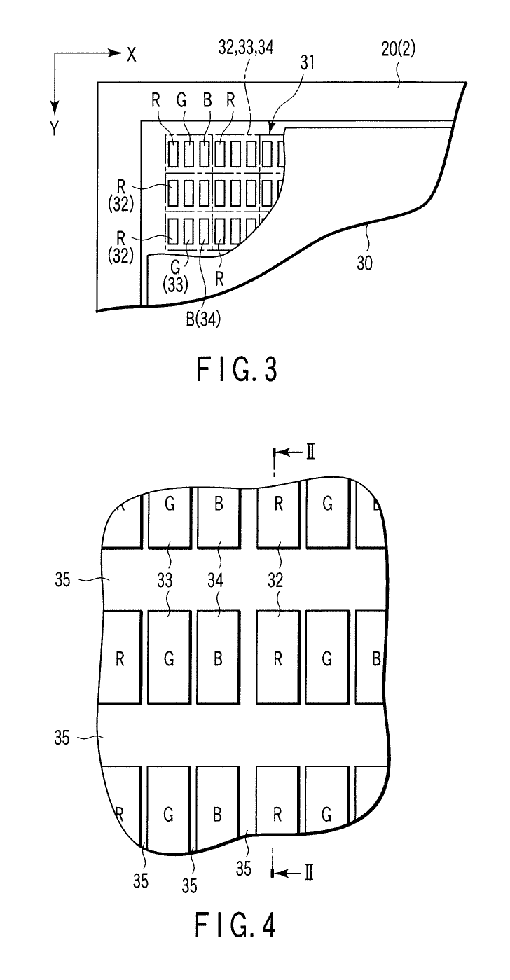

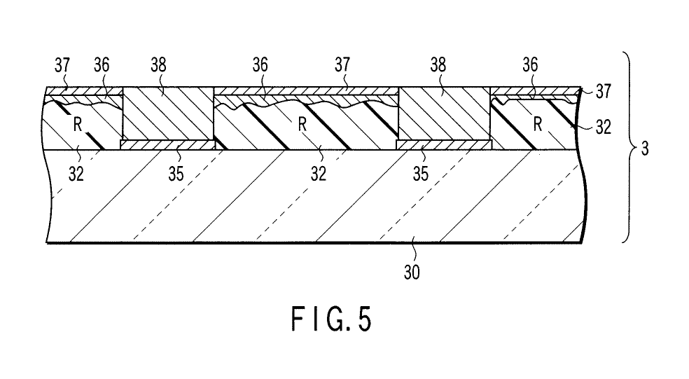

As shown in FIG. 3 and FIG. 4, the fluorescent surface 31 includes the fluorescent substance layers 32 (R), 33 (G) and 34 (B) on which three kinds of fluorescent substance to emit R, G, B lights upon collision with the electron emitted from the emitter of the rear panel 2 collides are arranged in predetermined order and area, and a light-shielding layer 35 which is arranged like a matrix dividing the fluorescent substance layers. The fluorescent substance layers 32 (R), 33 (G) and 34 (B) are formed like a stripe or a dot extending in one direction.

Assuming the longitudinal direction of the faceplate 3 namely the glass base material 30 as a first direction (X-direction) and the width direction orthogonal to the X-direction as a second direction (Y-direction), each of the fluorescent substance layers 32(R), 33(G) and 34(B) is formed like a stripe extending in the Y-direction. The fluorescent substance layers 32(R), 33(G) and 34(B) are arranged by taking three colors as one unit.

The light-shielding layer 35 is a mixture of carbon and binder, and its resistance value is set to 10³-10⁸ [Ω/□]. The binder content is defined to a maximum of 80%.

The light-shielding layer 35 is arranged in the first X direction with a predetermined gap (space) by taking three colors of fluorescent substance layers R (32), G (33) and B (34) as one unit to be divided into 800 lines, for example. The light-shielding layer 35 is also provided in a predetermined width (space) between the fluorescent substance layers of each color, that is, between R and G and between G and B.

The light-shielding layer 35 is arranged in 600 lines in the second Y direction. In other words, the fluorescent substance layers R/G/B as a pair of three colors are arranged in a predetermine order inside the sections defined by each line of the light-shielding layer 35, or in a window (35a) where the light-shielding layer 35 does not exist.

As seen from FIG. 3 and FIG. 4, the light shielding layer 35 is arranged in 800×3 rows and 600 columns in each of the X (row) and Y (column) directions.

Assuming that the size of one pixel is 0.6 mm in all sides, for example, concerning the Y-direction in which the fluorescent layer extends like a belt, the thickness of the area corresponding to the width (X-direction) is narrower than that of the horizontal line part. For example, the width of the vertical line part is 20-100 μm, preferably 40-50 μm, between pixels consisting of R, G and B, that is, B(34) and R(32), and in 20-100 μm, preferably 20-30 μm, between the remaining parts, that is, between R(32) and G(33), or between G(33) and B(34). On the other hand, the width of the horizontal line part is 150-450 μm, preferably 300 μm.

On the whole surface of the fluorescent surface 31 covering the fluorescent substance layers 32, 33 and 34, a thin metallic layer or a metal back layer 36 functioning as an anode electrode is formed to a predetermined thickness on the fluorescent substance layers 32, 33 and 34 having uneven surfaces, and used to reflect the light emitted from the fluorescent substance layer to the glass substrate 30. The term “metal back layer” is used in the present invention, but the material of this layer is not limited to metal. Other various materials may be used, as long as the layer functions as an anode. Before the metal back layer 36 is formed, a smoothing layer made of resin, for example, which can fix fluorescent substance particles may be provided on the whole area of the fluorescent substance layers 32, 33 and 34.

On the light-shielding layer 35, as shown in detail in FIG. 5, a getter cut material 38 is provided to prevent the light emitted from the fluorescent substance layer arranged in the window 35a from going into the adjacent fluorescent layer, and to decrease electrical conduction of the metal back layer 36 and a getter layer 37 laminated on the metal back layer 36. The getter (impurity absorbing) layer 37 is a thin layer of metal or chemical compound capable of absorbing impurity gas generated inside in the state the rear panel (first substrate) 2 and faceplate (second substrate) 3 are enclosed, or housed in the outer enclosure 5. The getter layer 37 is made of barium (Ba) or titanium (Ti). In FIG. 2 and FIG. 5, the light-shielding layer 35 and getter cut material 38 are formed independently of each other. They can be formed as one body, by appropriately setting a resistance value.

FIG. 5 shows the direction that each fluorescent substance layer becomes the same color, that is, the Y-direction in FIG. 3 along lines II-II in FIG. 4.

The metal back layer 36 and getter layer 37 are partially given an electrically discontinuous characteristic by the getter cut material 38 laminated on the light-shielding layer. Namely, the metal back layer 36 and getter layer 37 are electrically divided to be difficult to conduct at an optional position, compared with a completely sheet-like thin metallic film. Here, the term “divide” means no electrical continuity, but generally even an insulator does not have an infinite resistance value, and an electrical discontinuity does not occur in a strict sense. Therefore, in this application, “divided” means the state that by using a discontinuous film, even if a sweep voltage or substantially anode voltage is applied to between two substrates, an electric discharge is difficult to occur and a resistance is extremely increased compared with a continuous layer.

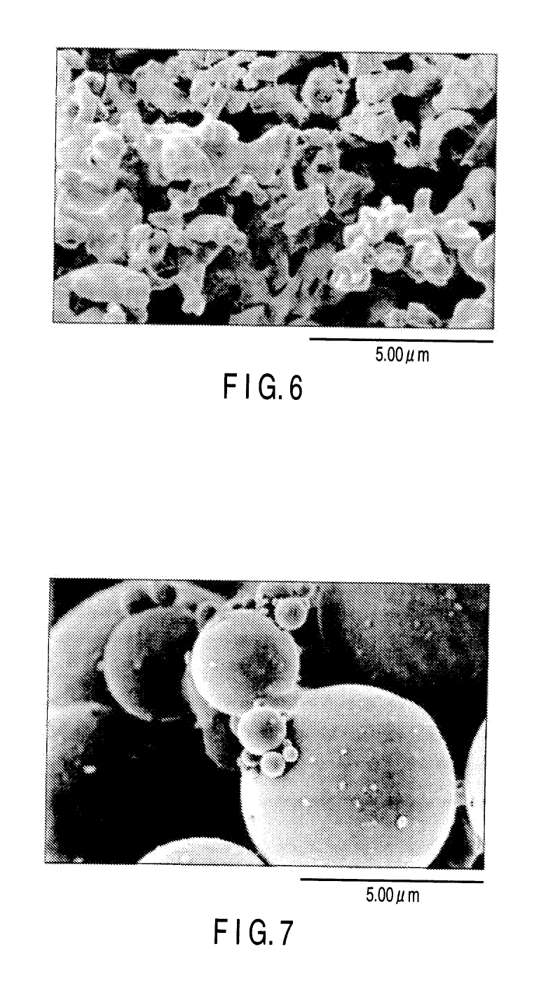

FIG. 6 to FIG. 8 show photo-micrographs of the getter cut material 38 of the composition shown in the following Table 1.

TABLE 1

| | | | [Comparative |
|---|---|---|---|
| | [1] | [2] | example] |
| Main material | Zn2SiO4 | SiO2 | SiO2 |
| Main material | 1.5 μm | 4.0 μm | 24 nm |
| particle diameter | | | |
| Main material form | Indefinite | Spherical | Indefinite |
| Resistance after | 10E5 | 10E5 | 10E5 |
| Ba flush [Ω/□] | | | |
| Resistance after | 10E5 | 0 | 0 |
| Ti flush [Ω/□] | | (Conductive) | (Conductive) |
| Discharged gas | 4.2E-11 | 4.2E-11 | 1.8E-10 |
| rate (Co/Co2) | | | |
| Dielectric voltage | 2.0 | — | 0.5 |
| [kV/mm] | | | |

FIG. 6 is a photo-micrograph of the experiment 1 shown in Table 1. The characteristics of the getter cut material 38 are the main material Zn₂SiO₄ and indefinite shape. According to the photo-micrograph, the main material is porous with a roughly uneven surface compared with the impurity size, and shaped such that it is difficult to find regularity. Therefore, it is considerable that electrical discontinuity can be obtained in the state that a predetermined amount of impurity is absorbed. In Table 1, 1.5 μm is shown in the box of particle diameter. This is the result of measurement by taking each projection or unevenness as a unit.

FIG. 7 is a photo-micrograph of the experiment 2 shown in Table 1. The characteristics of the getter cut material 38 are the main material SiO₂ and spherical shape. According to the photo-micrograph, the spherical shape (minimum surface area) is the same level as the experiment 1 in terms of discharge gas rate, but there is an electrical continuity. As shown in Table 1, when Ba and Ti are sequentially supplied as getter material by a method called flushing, a resistance value is decreased and substantial electrical continuity is obtained after the Ti flushing, or at the end of supplying the getter material.

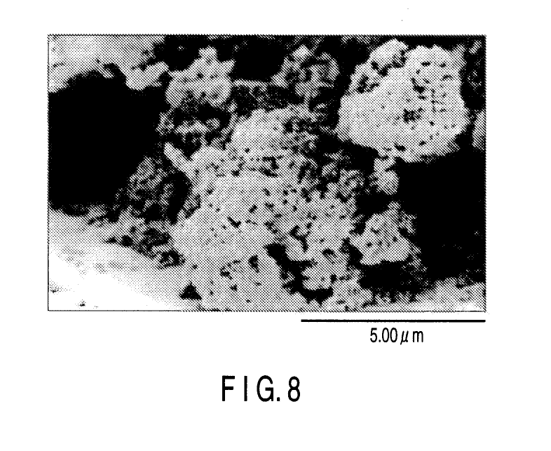

FIG. 8 is a photo-micrograph of the comparative example shown in Table 1. The characteristics of the getter cut material 38 are the main material SiO₄ and minute form close to powder, namely, an assembly of spheres. According to the photo-micrograph, the main material has an infinite number of holes on or near the surface and large absorbing area. As shown in Table 1, when Ba and Ti are sequentially supplied as getter material, a resistance value is decreased and substantial electrical continuity is obtained after the Ti flushing, or at the end of supplying the getter material.

According to Table 1 and FIGS. 6-8, it is significant to include Zn or Zn₂ in the main material, make porous and non-spherical shape, and compose/construct not to bury the holes under impurities in the state that a predetermined amount of impurities as an absorbing object is adhered. Though not specified at the present time, the most effective element in the experiment 1 include a gap if porous, composition/ratio of main material and binder, shape, particle diameter, thermal expansion coefficient, wettability or contact angle, gap size or diameter, and surface area. States of film or layer and distribution of gap are also considered as factors.

With the configuration described above, even if an electric discharge should occur between the faceplate (second substrate) 3 and rear panel (first substrate) 2, a peal value of discharge current is sufficiently decreased and damage caused by an electric discharge is reduced. Therefore, an image display apparatus can stably output a display image for a long time.

Next, a brief explanation will be given on an example of a process of manufacturing the above-mentioned fluorescent surface.

First, form a not-shown base processing agent to a predetermined thickness on one side of the glass substrate 30 used for the faceplate 3 (second substrate), and form a predetermined pattern of the light-shielding layer 35 made of black pigment or carbon by photolithography. The light-shielding layer 35 is given a pattern of a vertical line part and a horizontal line part arranged like a matrix.

Then, apply a fluorescent solution of ZnS, Y₃O₂ or Y₃O₂S group as a fluorescent substance layer 32 (R), 33 (G) and 34 (B) to a light-emitting space as a display area partitioned by a vertical line part and horizontal line part of the previously formed light-shielding layer 35, by a slurry method. Dry the applied fluorescent solution, make patterning by photolithography, and form the fluorescent substance layers 32, 33 and 34 of three colors red (R), green (G) and blue (B).

The getter cut material 38 may be laminated on the light-shielding layer 35, before forming the fluorescent substance layers. Of course, the getter cut material 38 can be formed after forming the fluorescent layers 32, 33 and 34.

Then, form a not-shown flat smoothing layer made of inorganic material such as aqua glass on the fluorescent surface 31, or the fluorescent substance layers 32, 33 and 33, by spraying. Form a metal back layer 36 made of a metallic film such as aluminum (Al) over the smoothing layer, by vacuum evaporation, CVD or spattering. According to the principle explained before, the metal back layer 36 is divided for each section (display area) of each fluorescent substance layers 32, 33 and 34, along at least one of the vertical line part and horizontal line part of the light-shielding layer 35.

Then, laminate the getter layer 37 on the metal back layer 36. Of course, the getter layer 37 is electrically discontinuously made by the getter cut material 38.

Insert the faceplate 3 provided with the fluorescent surface 31 and the rear plate 2 provided with electron-emitting elements 21 as electron sources into a vacuum unit, and enclose the faceplate 3 and rear panel 2 in a vacuum with a predetermined decreased pressure. Generally, as the getter layer 37 looses its function when exposed to the air, it is formed in the state that the space between the faceplate 3 and rear panel 2 is held vacuum.

Then, although not described in detail, the FED 1 is formed by connecting a not-shown power supply system for an anode, a scanning line driving circuit, and a signal line driving circuit.

In the FED configured as described above, the metal back layer 36 as a conductive thin film is electrically discontinuously partitioned or divided by the getter cut material 38. Therefore, even if an electric discharge occurs between the phase plate 3 and rear panel 1, a peak value of a discharge current can be sufficiently controlled, and damage caused by an electric discharge can be avoided.

As explained hereinbefore, with the structure described above, a dielectric strength for a sweep voltage causing an electric discharge in a thin metallic layer as a metal back layer can be increased. Therefore, even if an electric discharge should occur between two substrates, the magnitude of a discharge current is decreased, and the electron-emitting element and fluorescent surface can be prevented from being damaged or deteriorated in characteristics. As a result, a display apparatus free from degradation of picture quality caused by an internal electric discharge can be manufactured with high efficiency.

The invention is not limited to the aforementioned embodiments. Various modifications and variations are possible in a practical stage without departing from its essential characteristics. Each embodiment may be appropriately combined as far as possible. In such a case, the effect by the combination is obtained.

According to the present invention, the effect of a getter cut material which is provided on a mask member to partition the R, G and B fluorescent substance areas arranged in a predetermined order like a matrix, and prevents a getter material from becoming a continuous surface providing electrical continuity, can be increased. Therefore, even if an electric discharge should occur between substrates, the magnitude of the discharge current can be decreased.

Therefore, it is possible to prevent damages of an electron-emitting element and fluorescent surface and deterioration of characteristics. As a result, a display apparatus free from degradation of picture quality can be manufactured with high efficiency.

What is claimed is:

1. An image display apparatus comprising a first substrate which holds an electron beam source; and a second substrate which is opposite to the first substrate with a predetermined space, and holds a fluorescent substance layer to output a predetermined color light when receiving an electron beam output from the electron beam source, a light-shielding member to partition the fluorescent layer for each color, a thin metallic layer to cover the light-shielding member and fluorescent substance layer and to give a sweep voltage to an electron beam from the electron beam source, an impurity absorbing layer for absorbing impurities laminated on the thin metallic layer, and a cut member to partition at least one of the thin metallic layer and impurity absorbing layer to have an electrical resistance higher than a predetermined value; and the first and second substrates enclosed to a predetermined vacuum,
wherein the cut member is formed with main material of predetermined size arranged indefinitely, and made of porous material including a number of holes.

2. The image display apparatus according to claim 1, wherein the cut member includes Zn₂SiO₄.

3. The image display apparatus according to claim 1, wherein the cut member is shaped non-spherical.

4. An image display apparatus comprising:
a first substrate which holds an electron beam source;
a second substrate which is opposite to the first substrate with a predetermined space, and holds a fluorescent substance layer to output a predetermined color light when receiving an electron beam output from the electron beam source, a light-shielding member to partition the fluorescent layer for each color, a thin metallic layer covering the light-shielding member and fluorescent substance layer, formed at a predetermined angle in the light-shielding member to give a sweep voltage to an electron beam from the electron beam source, an impurity absorbing layer for absorbing impurities laminated on the thin metallic layer, and a cut member to partition at least one of the thin metallic layer and impurity absorbing layer to have an electrical resistance higher than a predetermined value;
a frame body which keeps the first and second substrate airtight with a predetermined space; and
a spacer member which keeps the predetermined space between the first and second substrates, and increases the intensity between the first and second substrates when keeping airtightness through the frame body.

5. The image display apparatus according to claim 4, wherein the cut member includes Zn₂SiO₄.

6. The image display apparatus according to claim 4, wherein the cut member is shaped non-spherical.

7. A method of manufacturing an image display apparatus, comprising:
forming a light-shielding layer on one side of a substrate;
forming R, G, B fluorescent substances in a predetermined order like a matrix in a section defined by a light-emitting layer;
eliminating a light-emitting layer along one direction of at least row or column direction of the light-emitting layer;
placing a porous material having a number of holes and shaped indefinite with predetermined size of main material arranged irregularly, in an area where the light-emitting layer is eliminated;
forming a thin metallic film on the light-shielding layer formed like a matrix;
providing a getter material for absorbing impurities over the thin metallic film;
opposing to the substrate provided with an electron source; and
evacuate to a predetermined vacuum after sealing the substrates.

8. The method of manufacturing an image display apparatus according to claim 7, wherein the cut member includes Zn₂SiO₄.

9. The method of manufacturing an image display apparatus according to claim 8, wherein the porous material is shaped non-spherical.
